(19) United States
(12) Patent Application Publication
(10) Pub. No.: US 2018/0288317 A1
(43) Pub. Date: Oct. 4, 2018

(54) CAMERA AND METHOD FOR DETECTING OBJECT MOVING RELATIVE TO THE CAMERA

(71) Applicant: SICK AG, Waldkirch (DE)

(72) Inventors: Richard NOPPER, Waldkirch (DE); Dirk STROHMEIER, Waldkirch (DE)

(21) Appl. No.: 15/937,344

(22) Filed: Mar. 27, 2018

(30) Foreign Application Priority Data
Mar. 30, 2017 (DE) 10 2017 106 831.7

(51) Int. Cl. H04N 5/232; G02B 3/00; H04N 5/235; H04N 9/07; G06K 9/00

(52) U.S. Cl. CPC H04N 5/23232; G02B 3/0037; G06K 2209/01; H04N 9/07; G06K 9/00335; H04N 5/2353

(57) ABSTRACT

A camera (10) for detecting objects (32) moving relative to the camera (10) in a conveying direction (34), comprising a light receiver (20) having a plurality of pixels (24) arranged in two lines (22a-b) in a line direction transverse to the conveying direction (34) and an evaluation unit (26) configured to generate a first and second image (40a-b) of a partial region of the object (32) by means of the two lines (22a-b), the images (40a-b) having a mutual offset in the line direction, to compute an image line of higher resolution than an original resolution from the first and second image (40a-b), and to compose an overall image from the image lines generated in the course of the movement, wherein reception optics (16) are arranged in front of the light receiver (20) for providing the mutual offset.

The invention relates to a camera and a method for detecting objects moving relative to the camera in a conveying direction.

In industrial applications, cameras are used in a variety of ways for automatically capturing object properties, such as for inspection or measurement of objects. Images of the object are generated and evaluated by image processing methods according to the task. Another application of cameras is reading codes. Images of objects bearing the codes are generated by means of an image sensor, code areas are identified in the images, and the codes are decoded. Camera-based code readers are easily able to read code types other than one-dimensional bar codes, which are two-dimensional like a matrix code and provide more information. Moreover, automatic text detection of printed addresses (OCR, Optical Character Recognition) or handwriting is basically a reading of codes. Typical fields of application of code readers are supermarket cash registers, automatic parcel identification, sorting of mail, baggage handling in airports and other logistics applications.

A common detection situation is the mounting of the camera at a conveyor belt. The camera takes pictures during the relative movement of the object flow on the conveyor belt and initiates further processing steps depending on the detected object properties. Such processing steps may for example be further processing adapted to the specific object with a machine acting on conveyed objects, or a change of the object flow in that certain objects are taken from the object flow as part of a quality control or in that the object flow is sorted into a plurality of partial object flows. If the camera is a camera-based code reader, the objects are identified by the attached codes for correct sorting or similar processing.

The situation of a movement of the object relative to the camera in an object flow can be used to successively take images line by line and to then assemble the image lines into an image. A line camera is sufficient to detect the objects in high image quality with a high-intensity illumination. The resolution of these images is determined by the resolution of the line sensor in the line direction transverse to the movement of the object flow, and by the image acquisition frequency in the conveying direction. In order to achieve a higher image resolution, a line sensor with a larger number or density of pixels can be used. However, this increases the manufacturing costs. Increasing the image pickup frequency, on the other hand, reduces the integration time and is therefore only possible within limits.

There are known methods for increasing the effective image resolution with the same physical pixel resolution by taking several images with slight mutual offset and a subsequent common evaluation (super sampling, super resolution).This requires the mutually offset images as a starting point. This can be achieved by an actor which generates fast movement of the image sensor. However, such an actor is not robust and difficult to synchronize.

U.S. Pat. No. 6,166,831 A therefore provides an image sensor with two image lines whose pixels are slightly offset from one another in the line direction. While this, in principle, solves the problem of capturing suitable images, it requires a specifically adapted image sensor. Moreover, the image resolution in the direction transverse to the image lines is not improved.

US 2011/0115793 A1 is concerned with image processing for increasing the resolution by TDI (Super-Resolution Time Delay and Integrate). The camera is moved in both the longitudinal and transverse directions between two images in order to deliberately get outside the pixel grid. As mentioned above, such movements are very difficult to synchronize and not robust.

US 2009/0284666 A1 is about a line projector according to the scanning principle. There are two pixel lines with an offset of half a pixel both in horizontal and vertical direction which project an image of accordingly increased resolution in their superposition. Again, this requires special hardware components that additionally, while similar in their principle, cannot actually be transferred to a line camera because they project rather than capture images.

U.S. Pat. No. 9,501,683 B1 discloses a bar code reader with increased resolution. It is proposed to record a respective code section twice, but with a non-integer relative pixel offset, and then to combine the two sections to a higher resolution image. Several measures are mentioned to achieve the pixel offset. These include a physical pixel offset on the image sensor and an increased image capture frequency, with the previously mentioned disadvantages that only special semiconductor components can be used and that integration times inevitably have to be reduced, respectively. In another embodiment, the camera is rotated or tilted relative to the object flow.

EP 3 012 778 A2 discloses a camera with a dual line receiver. However, the two image lines are not used to increase the resolution, but to obtain color images. For this purpose, the object flow is illuminated stroboscopically with different spectral bands, and the two lines synchronize their recording time windows in accordance with the respective color to be recorded.

U.S. Pat. No. 6,429,953 B1 is both about increased resolution and color detection. Pixels having corresponding color filters are offset with respect to one another in order to detect the various required images. Again, special semiconductor components are necessary.

It is therefore an object of the invention to achieve an increased image resolution of a camera in a simple manner.

This object is satisfied by a camera for detecting objects moving relative to the camera in a conveying direction, the camera comprising a light receiver having a plurality of light receiving pixels arranged in at least two lines in a line direction transverse to the conveying direction and a control and evaluation unit configured to generate a first image and a second image of a partial region of the object by means of the two lines, the images having a mutual offset at least in the line direction, to compute an image line of higher resolution than an original resolution of the light receiver from the first image and the second image, and to compose an overall image from the image lines generated in the course of the movement of the objects, wherein reception optics are arranged in front of the light receiver for providing the mutual offset between the first image and the second image.

The object is also satisfied by a method for detecting objects by a light receiver of a camera, the objects moving relative to the camera in a conveying direction and the light receiver comprising a plurality of light receiving pixels arranged in at least two lines in a line direction transverse to the conveying direction, wherein a first image and a second image of a partial region of the object are generated by means of the two lines, the images having a mutual offset at least in the line direction, wherein an image line having a higher resolution than an original resolution of the light receiver is computed from the first image and the second image and an overall image is composed from the image lines generated in the course of the movement of the objects, and wherein the mutual offset between the first image and the second image is provided by reception optics arranged in front of the light receiver.

The camera comprises a light receiver or image sensor having at least two lines of light receiving elements or light receiving pixels. Two images which are mutually offset at least in the line direction are generated for computing an image line of higher resolution from that. This means that the achieved resolution is better than the original resolution corresponding to the pixel size or pixel density of the lines of light receiving pixels. From these image lines of improved resolution, an overall image is successively generated in the course of the relative movement of camera and objects in a conveying direction. The conveying direction is transverse, in particular perpendicular to the line direction, wherein some deviating angle is allowed. By additional offset of the images in the conveying direction or other measures, image resolution can also be improved in that direction. Moreover, more than two lines of light receiving pixels can be used in order to further improve resolution or other parameters such as image brightness or color detection.

The invention starts from the basic idea of achieving the offset of the images by the light paths. To that end, reception optics are arranged in front of the light receiver which provide the offset between the images. These reception optics preferably are static, i.e. immovable with respect to the light receiver and the camera, respectively. This can be combined with additional measures in order to in total achieve the desired offset. Throughout this specification, the terms preferred or preferably refer to an advantageous, but completely optional feature.

The invention has the advantage that an increased image resolution is achieved while avoiding all the problems mentioned in the introduction. It allows use of a standard image sensor with regularly arranged light receiving pixels, for example a double-line or multi-line receiver or a matrix receiver with only certain lines being used. The area requirements of this image sensor do not increase, the original image resolution and thus pixel arrangement (pitch) remain the same. No moving parts are required in the camera for achieving the offset so that synchronization with the conveying movement is no more difficult than in a conventional line camera without any increase in resolution.

The light receiving pixels are preferably arranged in a mutual pixel distance, wherein the offset of the images corresponds to a fraction of the pixel distance. The distance between pixels (pixel pitch) determines the original resolution of the light receiver. It is also conceivable that the light receiving pixels have different pixel pitch in different lines and thus more than one original resolution. In that case, the higher resolution after common evaluation of the images is better than the finer resolution among the original resolutions. The offset of the two images corresponding to a fraction of the pixel pitch advantageously is outside the pixel grid. A fraction >1 is not excluded, where the integer part does not contribute to leaving the pixel grid.

The control and evaluation unit is preferably configured to generate the first image and the second image with an offset also transverse to the line direction, and to generate an overall image of higher resolution than the original resolution also in the conveying direction. In most applications, the orientation of the objects with respect to the camera is arbitrary. Therefore, it is advantageous if the image resolution is improved in both dimensions and not only in the line direction.

The reception optics preferably also provide the offset in the conveying direction. Thus, the resolution improvement in the second direction is also achieved by a simple measure as for the line direction, with the advantages already mentioned above.

The control and evaluation unit preferably is configured to generate the first image and the second image with staggered exposure time windows. This is an alternative or supplement to an offset in the conveying direction by the receiving optics and consequently also serves to improve the resolution in the conveying direction. For example, the exposure time windows for the two images mesh like teeth. The time offset due to the staggered exposure time windows is transferred to the desired spatial offset of the images in conveying direction by the relative movement. Preferably, the offset is just the fraction of the pixel pitch corresponding to the offset of the images in line direction. In principle, higher resolution in conveying direction could also be achieved by an increased image acquisition frequency. However, this reduces the integration time and is therefore disadvantageous. Staggered exposure time windows achieve the same effect with regard to image resolution without negative effects, where the integration time can be maintained.

The reception optics preferably comprise a plurality of microlenses which are, in the line direction, at least one of tilted or offset relative to a grid of the light receiving pixels. Both measures of tilting and offset have the effect of a shift of the image with respect to the pixel grid and can be used as alternatives or supplement one another in a combination. Microlenses can be arranged relatively easily in front of an image sensor, also as a retrospective production step on a standard component, and their optical properties are largely free to determine by design of the tool. Since a relative offset is desired, it is sufficient to have microlenses in front of only one of the two lines. In other embodiments, microlenses having their own characteristics are used for each line. The tilt of a microlens can be achieved through combination with a wedge or prism, both in an integral optical combination element or in that an array of wedge or prismatic structures is assigned to the microlenses.

The reception optics preferably comprise a plurality of microlenses which are, in the conveying direction, at least one of tilted or offset relative to a grid of the light receiving pixels. This achieves an increase in resolution in the conveying direction. Otherwise, what has been said about embodiments with tilt or offset in line direction applies mutatis mutandis. It is conceivable and particularly advantageous to tilt and/or offset microlenses relative to the pixel grid both in the line and in the conveying direction in order to obtain the advantages of a resolution increase in both dimensions.

Preferably, the microlenses for the one line are tilted or offset in a direction opposite to the microlenses for the other line. Then, the individual offset per light receiving pixel can be relatively small, which sometimes can be optically achieved more easily and with fewer distortions. For example, the microlenses in each line contribute half the desired offset in line and/or conveying direction, resulting in the desired overall offset in a total consideration of both lines.

The reception optics preferably comprise a diffractive optical element (DOE). With a DOE, a desired light redistribution is possible on small spatial scales, and once a DOE has been calculated and the required tool has been created, it can very easily be combined with an image sensor. In particular, similar effects and advantages are possible by diffraction as have been discussed in the context of microlenses.

The reception optics preferably comprise at least one free-form surface. On the one hand, these may be free-form micro-optics. This leaves more design degrees of freedom compared to microlenses. However, it is also conceivable to design a macroscopic receiving optics with free-form surface, which creates the desired offset for all light-receiving pixels or at least larger areas of the light receiver. In particular, such a free-form can be combined with a receiving objective for focusing

The reception optics preferably comprise at least one tilted or wedge-shaped surface. Again, both embodiments with micro-optics and macroscopic receiving optics are conceivable. In the former case, this results in a line or matrix arrangement of tilted surfaces, in particular small wedges or prisms. This can also be combined with microlenses, in particular microlenses with a wedge surface, or with a DOE. In the latter case, a wedge, a tilted surface or a prism is provided, which tilts the optical axis of the light receiver for at least one line of light receiving elements. Several such optical elements can complement one another for the desired offset in the line direction and/or the conveying direction.

The reception optics preferably have different color filters for the lines. Then, color images can be generated. In this embodiment, the light receiver preferably comprises more than two lines of light receiving pixels. One example are red, green and blue lines with staggered mutual offset in combination with at least one additional line without color filter for a grayscale image. The color filters can also vary within a line. It is possible to provide twice as many, or at least more, light receiving pixels with a green color filter in order to support the physiological perception in accordance with a Bayer pattern.

The method according to the invention can be modified in a similar manner and shows similar advantages. Further advantageous features are described in an exemplary, but non-limiting manner in the dependent claims following the independent claims.

The invention will be explained in the following also with respect to further advantages and features with reference to exemplary embodiments and the enclosed drawing. The Figures of the drawing show in:

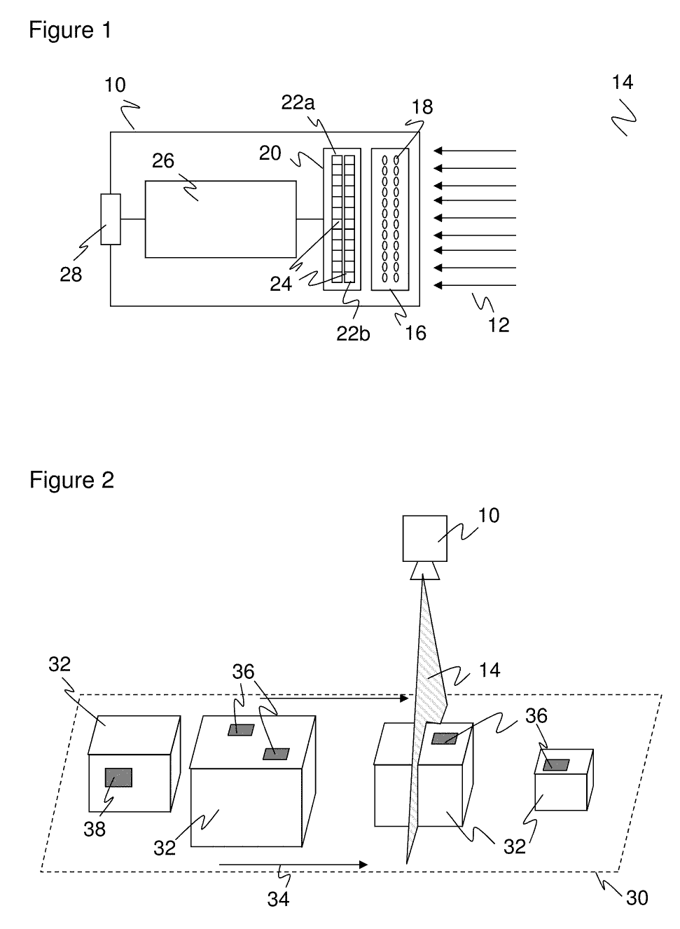

FIG. 1 a simplified block diagram of a camera;

FIG. 2 a three-dimensional view of an exemplary application of a camera mounted at a conveyor belt;

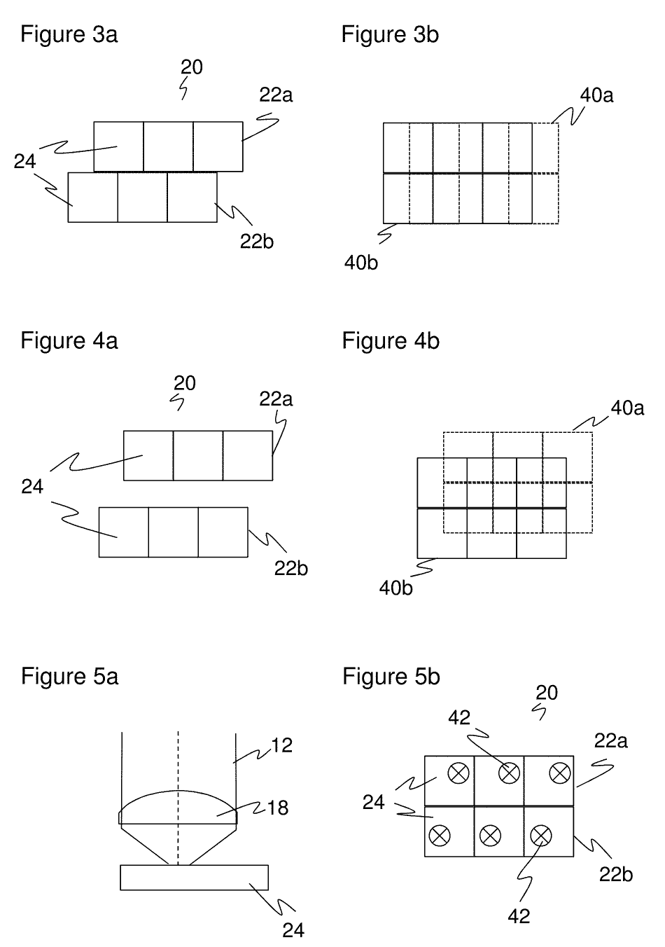

FIG. 3a a schematic view of two pixel lines having a mutual offset in a line direction;

FIG. 3b an effective pixel matrix resulting from the offset according to FIG. 3a;

FIG. 4a a schematic view of two pixel lines having a mutual offset both in line direction and the perpendicular direction;

FIG. 4b an effective pixel matrix resulting from the offset according to FIG. 4a;

FIG. 5a a schematic representation of a pixel and an associated microlens having an offset with respect to the pixel center;

FIG. 5b a schematic view of two pixel lines and the optical axes offset by microlenses;

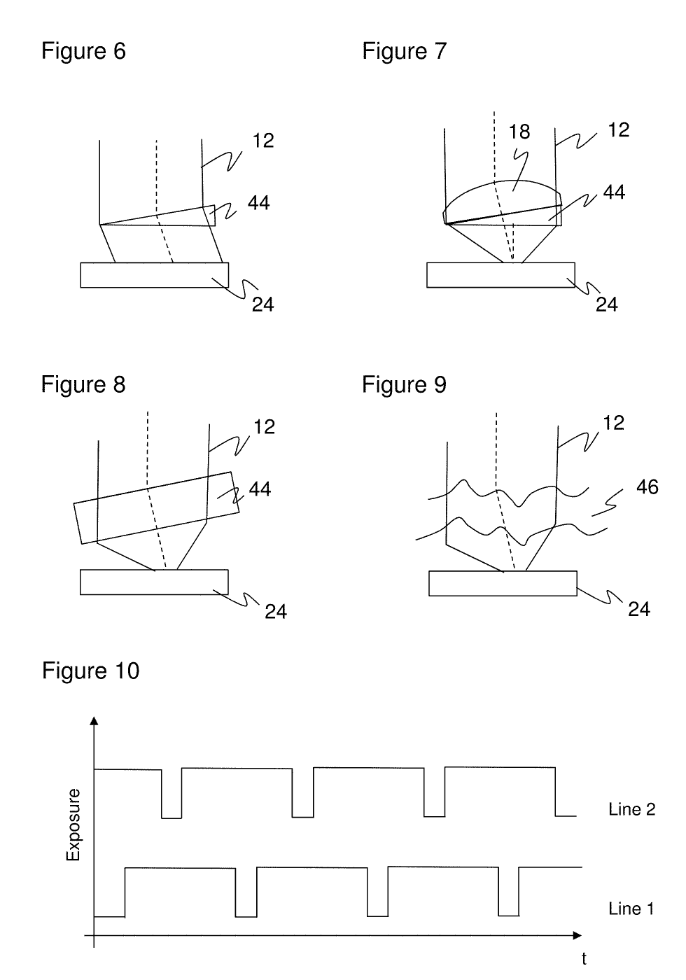

FIG. 6 a schematic representation of a pixel and an associated wedge-shaped optical element;

FIG. 7 a schematic representation of a pixel and an associated microlens having an offset with respect to the pixel center, the microlens being combined with a wedge-shaped optical element;

FIG. 8 a schematic representation of a pixel and an associated optical element in the form of an oblique surface;

FIG. 9 a schematic representation of a pixel and an associated optical element having at least one free-form surface; and

FIG. 10 a representation of mutually offset exposure time windows for two lines of light receiving pixels.

FIG. 1 shows a very simplified block diagram of a camera 10, which can for example be used for measuring or inspection of objects and for detecting codes and reading their contents. The camera 10 detects reception light 12 from a detection area 14 through reception optics 16. The reception optics 16 are schematically shown by two lines of micro lenses 18. This should be understood as an example and more symbolic. Some possible embodiments of the reception optics 16 are explained in more detail below with reference to FIGS. 5 to 9. Moreover, reception optics 16 can be supplemented by further optical elements of a conventional camera objective.

A light receiver 20 having at least two lines 22a-b of light-sensitive receiving pixels 24 generates image data of the detection area 14 and any present objects and code areas from the incident reception light 12. The light receiver 20 is preferably fixedly installed in the camera 10, i.e. not movable with respect to the camera 10. The receiving pixels 24 are preferably identical to each other, so that equivalent image data are generated. Alternatively, differences are conceivable, for example, different pixel size and thus higher sensitivity in one line 22a-b and higher spatial resolution in the other line 22b-a.

The two lines 22a-b are preferably integrated on the same wafer, although separate line sensors are not excluded. It is also conceivable to use a matrix arrangement of receiving pixels and to select specific lines 22a-b.

In order to illuminate the detection area 14, the camera 10 may comprise an integrated or external illumination device, which is not shown and in particular adapts its illumination field with transmission optics to the detection area of the light receiver 20 in a line shape.

The image data of the light receiver 20 are read out by a control and evaluation unit 26. The evaluation unit 26 is implemented on one or more digital components, for example microprocessors, ASICs (Application-Specific Integrated Circuit), FPGAs (Field Programmable Gate Array) or the like, which may also be provided outside the camera 10 in parts or in its entirety. Part of the evaluation consists of combining several images of the two lines 22a-b with one another in order to obtain a higher image resolution, as explained in more detail below with reference to FIGS. 3 and 4. In addition, the evaluation unit 26 is configured to line up image lines acquired in the course of a relative movement of camera 10 and objects to an overall image.

Otherwise, during the evaluation, the image data can be filtered for preprocessing, smoothed, normalized in their brightness, clipped to specific areas or binarized. Then, for example, interesting structures are recognized and segmented, such as individual objects, lines or code areas. These structures can be measured or checked for specific properties. If codes are to be read, they are identified and decoded, i.e. the information contained in the codes is read.

Data can be output at an interface 28 of the camera 10, both evaluation results such as code information which has been read or measurements and inspection results which have been determined, as well as data in various processing stages such as raw image data, preprocessed image data, identified objects or code image data not yet decoded. Conversely, it is possible to parameterize the camera 10 via the interface 28.

FIG. 2 shows a possible application of the camera 10 which is mounted at a conveyor belt 30 conveying objects 32 through the detection area 14 of the camera 10, as indicated by the arrow 34. The objects 32 may have code areas 36 on their outer surfaces. The task of the camera 10 is to detect properties of the objects 32 and, in a preferred application as a code reader, to detect the code areas 36, to read and decode the codes therein, and to assign them to the respective object 32. In order to also detect code areas 38 at the sides, additional cameras 10 from different perspectives are preferably used, which are not shown.

The detection area 14 of the camera 10 is a plane having a line-shaped reading field, in accordance with the structure of the light receiver 20 and its receiving pixels 24 arranged in lines 22a-b. By imaging the objects 32 line-wise in the conveying direction 34, an overall image of the conveyed objects 32 including the code areas 36 is successively created.

FIG. 3a shows a schematic view of a small section of the two lines 22a-b, which preferably do not comprise three, but a few hundreds, thousands or even more receiving pixels 24. The two lines 22a-b are mutually offset by half a pixel distance (pixel pitch) in the line direction, wherein alternatively another fraction may be used. Embodiments with more than two lines 22a-b are also conceivable, in particular n lines with an offset of 1/n*pixel pitch each.

FIG. 3b schematically shows a resulting pixel matrix. The images 40a-b of the two lines 22a-b superimpose and form a denser pixel grid than the original images due to the mutual offset. The offset is thus used for an increase of the resolution in the line direction. For this purpose, the images 40a-b are combined to the resulting pixel matrix in a suitable manner by averaging or other interpolation filters. The basic principle of generating a higher-resolution image from a plurality of mutually offset lower-resolution images is known (super sampling, superimposing, super resolution).

FIG. 4a is a schematic view of a section of the two lines 22a-b similar to FIG. 3a. The difference is that the two lines 22a-b have an offset of half a pixel pitch not only in the line direction, but also transverse thereto. The direction transverse to the line direction is also referred to as the conveying direction based on the exemplary application according to FIG. 2. The two lines 22a-b are therefore separated from one another by half a free line. Again, alternatively, other fractions than a half pixel pitch and more than two lines 22a-b are conceivable.

FIG. 4b schematically shows a resulting pixel matrix. Due to the offset both parallel and perpendicular to the line 22a-b, there is a denser effective pixel grid in both axes.

Therefore, an increase in resolution is achieved both in line direction and conveying direction, or in x direction and y direction, respectively. As will be explained later on with reference to FIG. 10, the resolution in conveying direction can also be increased by other measures.

It is conceivable to obtain the offset of the two lines 22a-b shown in FIGS. 3a and 4a by a physical arrangement of the photosensitive areas or light receiving pixels 24. However, in that case it is necessary to use a special image sensor as the light receiver 20. According to the invention, it is advantageous to understand the arrangements according to FIGS. 3a and 4a as effective pixels of the image in relation to the detection area 14. Then, the offset is achieved by means of the reception optics 16 which modifies the light paths so that effectively an image is formed as would be generated by receiving pixels 24 in the offset physical arrangement as shown. Accordingly, an image offset in the line direction and/or the conveying direction is generated. The receiving pixels 24 of the light receiver 20 themselves can be arranged without offset as in a conventional image sensor. However, the invention does also not exclude a physical offset.

FIG. 5a shows, as one embodiment of such reception optics 16, a schematic representation of a receiving pixel 24 and an associated microlens 18 which is offset with respect to a center of the receiving pixel 24. The offset of the microlenses 18 is different for the two lines 22a-b. This can in particular be achieved in that only one line 22a-b has any microlenses 18 in the first place. However, it is advantageous to divide the desired offset by assigning microlenses to the two lines 22a-b having an offset in opposite directions.

FIG. 5b illustrates an example of the effect of microlenses 18 offset in this way. The optical axis 42 of the receiving pixels 24 is offset relative to their center due to the effect of the respective microlens 18. In the illustrated example, there is an offset of one quarter of the pixel pitch towards the upper right in the upper line 22a and a corresponding offset in the opposite direction in the lower line 22b towards the lower left. In total, the two lines 22a-b are thus mutually offset by half a pixel pitch in the line direction and the conveying direction. This is of course only one numerical example. The offset may be limited to only the line direction or only the conveying direction, may add up to more or less than half a pixel pitch, and may be distributed over the lines 22a-b in virtually any other manner.

FIG. 7 illustrates a further embodiment of the reception optics 16 in a representation similar to FIG. 5a. Here, instead of a microlens 18, an optical tilting element 44 in the form of a wedge element or a prism is provided. As a result, the optical axis of the associated receiving pixel 24 is practically bent, and thus the offset is generated. The optical tilting element 44 may be a micro-optic as shown. However, a macroscopic tilting element for all receiving pixels 24 of a line 22a-b or at least a larger partial area of the light receiver is also conceivable.

FIG. 7 illustrates a combination of a microlens 18 and an optical tilting element 44.

Thus, the effects explained with reference to FIGS. 5 and 6 add up. The microlens 18 can be formed integrally with the optical tilting element 44. However, two layers of microlenses 18 and optical tilting elements 44 as well as the combination of microlenses 18 with a macroscopic tilting element are also conceivable. Finally, it is also possible to tilt a microlens 18 by itself, without combining it with a separate optical tilting element 44.

FIG. 8 shows another alternative of an optical tilting element 44, which now is designed with two plane surfaces, but overall is arranged at an angle to the surface of the receiving pixel 24. All variants as with an optical tilting element 44 designed as a wedge or a prism are possible.

FIG. 9 shows a further embodiment of the reception optics 16, which is now formed as an optical element having at least one free-form surface 46 in contrast to the previous embodiments. Such free-form surfaces have even more degrees of freedom for the optical design than, for example, spherical or aspherical microlenses 18. As an alternative for specific micro-optics having a free-form surface 46, it is possible to generate the desired offset for a plurality of, or even all, receiving pixels in a line 22a-b by a macroscopic optical element having a free-form surface.

Further embodiments for the reception optics 16 are possible with diffractive optical elements (DOEs), which are not shown. These can also be used to generate the pixel-related light redistributions as described. The embodiments explained with reference to FIGS. 5 to 9 are not to be understood as limiting. Further to combinations already mentioned, these measures can almost arbitrarily be used in any complementary manner, and in addition to such refractive combinations, use of a DOE is possible in each case. However, there are other possibilities that can be used alternatively or in addition. On the one hand, this is an adjustment of the image acquisition frequency, if the disadvantage of the shorter integration times can be accepted.

FIG. 10 shows mutually offset exposure time windows for the two lines 22a-b of receiving pixels 24. Exposure time window denotes the time interval in which the receiving pixels 24 integrate the reception light 12. The representation is to be understood purely schematically, an exposure time window does not have to fill out the duration between two images as shown. Rather, the exposure time is chosen according to the desired intensity levels and similar factors as usual.

The special feature is that the exposure time windows of the two lines 22a-b are synchronous, but have a phase shift. In particular, the delay of the exposure time window of the second line 22b with respect to the exposure time window of the first line 22a corresponds to half a pixel pitch or, more generally, to the offset which also applies in the line direction. The adaptation to the conveying speed is not a new task, since the image acquisition should anyway be selected accordingly for a uniform resolution in the line and conveying direction, even in the conventional case without increased resolution by offset pixels. The exposure time windows given by that image acquisition merely have to be time-offset by 50%, or another fraction, between the two lines 22a-b.

With adapted exposure time windows, there are further possible combinations. It is conceivable to achieve the increased resolution in the line direction by means of the reception optics 16, in particular by microlenses 18, while in the conveying direction, the image acquisition is increased, or staggered exposure time windows are used. This may lower the requirements for the light receiver 20 and the reception optics 16, and thus possibly lead to a more practical solution.

1. A camera (10) for detecting objects (32) moving relative to the camera (10) in a conveying direction (34), the camera (10) comprising
a light receiver (20) having a plurality of light receiving pixels (24) arranged in at least two lines (22a-b) in a line direction transverse to the conveying direction (34)
and a control and evaluation unit (26) configured
to generate a first image (40a) and a second image (40b) of a partial region of the object (32) by means of the two lines (22a-b), the images (40a-b) having a mutual offset at least in the line direction,
to compute an image line of higher resolution than an original resolution of the light receiver (20) from the first image (40a) and the second image (40b),
and to compose an overall image from the image lines generated in the course of the movement of the objects (32),
wherein reception optics (16) are arranged in front of the light receiver (20) for providing the mutual offset between the first image (40a) and the second image (40b).

2. The camera (10) according to claim 1,
wherein the light receiving pixels (24) are arranged in a mutual pixel distance, and wherein the offset of the images (40a-b) corresponds to a fraction of the pixel distance.

3. The camera (10) according to claim 1,
wherein the control and evaluation unit (26) is configured to generate the first image (40a) and the second image (40b) with an offset also transverse to the line direction, and to generate an overall image of higher resolution than the original resolution also in the conveying direction (34).

4. The camera (10) according to claim 3,
wherein the reception optics (16) also provide the offset in the conveying direction (34).

5. The camera (10) according to claim 3,
wherein the control and evaluation unit (26) is configured to generate the first image (40a) and the second image (40b) with staggered exposure time windows.

6. The camera (10) according to claim 1,
wherein the reception optics (16) comprise a plurality of microlenses (18) which are, in the line direction, at least one of tilted or offset relative to a grid of the light receiving pixels (24).

7. The camera (10) according to claim 6,
wherein the microlenses (18) for the one line (22a-b) are tilted or offset in a direction opposite to the microlenses (18) for the other line (22b-a).

8. The camera (10) according to claim 1,
wherein the reception optics (16) comprise a plurality of microlenses (18) which are, in the conveying direction (34), at least one of tilted or offset relative to a grid of the light receiving pixels (24).

9. The camera (10) according to claim 8,
wherein the microlenses (18) for the one line (22a-b) are tilted or offset in a direction opposite to the microlenses (18) for the other line (22b-a).

10. The camera (10) according to claim 1,
wherein the reception optics (16) comprise a diffractive optical element.

11. The camera (10) according to claim 1,
wherein the reception optics (16) comprise at least one free-form surface (46).

12. The camera (10) according to claim 1,
wherein the reception optics (16) comprise at least one tilted or wedge-shaped surface (44).

13. The camera (10) according to claim 1,
wherein the reception optics (16) have different color filters for the lines (22a-b).

14. A method for detecting objects (32) by a light receiver (20) of a camera (10), the objects (32) moving relative to the camera (10) in a conveying direction (34) and the light receiver (20) comprising a plurality of light receiving pixels (24) arranged in at least two lines (22a-b) in a line direction transverse to the conveying direction (34),
wherein a first image (40a) and a second image (40b) of a partial region of the object (32) are generated by means of the two lines (22a-b), the images (40a-b) having a mutual offset at least in the line direction,
wherein an image line having a higher resolution than an original resolution of the light receiver (20) is computed from the first image (40a) and the second image (40b)
and an overall image is composed from the image lines generated in the course of the movement of the objects (32),
and wherein the mutual offset between the first image (40a) and the second image (40b) is provided by reception optics (16) arranged in front of the light receiver (20).
